(19) United States
(12) Patent Application Publication
(10) Pub. No.: US 2025/0360712 A1
(43) Pub. Date: Nov. 27, 2025

(54) INK-REPELLENT MEMBER, INK JET HEAD, METHOD OF PRODUCING ARTICLE, AND LIQUID EJECTION APPARATUS

(71) Applicant: CANON KABUSHIKI KAISHA, Tokyo (JP)

(72) Inventors: TADAHIRO MIMURA, Kanagawa (JP); YOHEI MIYAUCHI, Tokyo (JP); JUNRI ISHIKURA, Tokyo (JP); KOJI SASAKI, Chiba (JP)

(21) Appl. No.: 19/208,821

(22) Filed: May 15, 2025

(30) Foreign Application Priority Data
May 21, 2024 (JP) 2024-082824

(51) Int. Cl. B41J 2/165; B41J 2/14; C09D 171/02

(52) U.S. Cl. CPC B41J 2/16502; B41J 2/1433; C09D 171/02

(57) ABSTRACT

Provided is an ink-repellent member including an underlying portion containing an inorganic oxide, the ink-repellent member having a fluorine compound bonded to a surface of the underlying portion, wherein the fluorine compound has a chain structure, and is bonded to the surface by forming a phosphonic acid ester structure at each of both ends thereof.

### BACKGROUND OF THE INVENTION

### Field of the Invention

The present invention relates to an ink-repellent member, an ink jet head, a method of producing an article, and a liquid ejection apparatus. Description of the Related Art

As a device that ejects an ink (hereinafter referred to as “ink jet head”), there have been known a bubble jet head that instantaneously vaporizes an ink through use of a heater to fly liquid droplets, a piezo jet head that propels liquid droplets through use of a piezoelectric element, and the like. To record a high-quality image through use of an ink jet head, it is required that ink droplets be ejected from ejection orifices that eject the ink with their satisfactory straightness along a predetermined direction. However, when a liquid droplet residue adheres to an orifice plate surface on the periphery of the ejection orifices, the ink droplets are dragged by the residue at the time of the ejection of the ink droplets to cause deflection in an ejection direction, with the result that the ink droplets may fly out of the predetermined direction. In view of the foregoing, in order to suppress the adhesion of the liquid droplet residue on the periphery of the ejection orifices, an ink-repellent film is formed on the periphery of the ejection orifices to provide an ink-repellent member.

For example, in Japanese Patent Application Laid-Open No. 2015-3483, there is a disclosure that an underlying film formed of an inorganic oxide is arranged on an orifice plate surface, and a fluorine-containing silane coupling agent (hereinafter sometimes referred to as “fluorine compound”) is chemically bonded thereto to form an ink-repellent film.

In addition, in an ink jet head, in order to remove a liquid droplet residue, paper dust, and the like, the orifice plate surface is generally cleaned with a wiper. Thus, the ink-repellent member is required to have ink resistance and sliding resistance.

It has been generally known that, as in Japanese Patent Application Laid-Open No. 2015-3483, when a fluorine compound serving as an ink-repellent film is bonded to an underlying portion containing an inorganic oxide, a fluorine-containing silane coupling agent is used.

An ink-repellent member including an ink-repellent film, in which an underlying portion containing an inorganic oxide is sufficiently coated with the ink-repellent film, and which is excellent in sliding resistance and ink resistance, has been required.

### SUMMARY OF THE INVENTION

According to one aspect of the present invention, there is provided an ink-repellent member including an underlying portion containing an inorganic oxide, the ink-repellent member having a fluorine compound bonded to a surface of the underlying portion, wherein the fluorine compound has a chain structure, and is bonded to the surface by forming a phosphonic acid ester structure at each of both ends thereof.

In addition, according to one aspect of the present invention, there is provided an ink jet head including: the above-mentioned ink-repellent member; and an ejection orifice arranged on a side of the ink-repellent member on which the underlying portion and the fluorine compound are arranged, the ejection orifice being configured to eject a liquid.

In addition, according to one aspect of the present invention, there is provided a method of producing an article including ejecting a liquid through use of the above-mentioned ink jet head, wherein the liquid is an ink containing a functional material for forming one of a functional thin film and a functional element.

Further features of the present invention will become apparent from the following description of exemplary embodiments with reference to the attached drawings.

### BRIEF DESCRIPTION OF THE DRAWINGS

FIG. 1A is a top view of an ink jet head 100 according to one embodiment of the present invention.

FIG. 1B is a bottom view of the ink jet head 100 according to one embodiment of the present invention.

FIG. 1C is a partial perspective view for illustrating a cross-section taken along the line A-A′ illustrated in FIG. 1A and FIG. 1B.

FIG. 2 is a schematic view for illustrating a state of an ink-repellent member according to one embodiment of the present invention, the ink-repellent member having a fluorine compound bonded to a surface of an underlying portion.

### DESCRIPTION OF THE EMBODIMENTS

An ink-repellent member, an ink jet head, and the like according to embodiments of the present invention are described with reference to the drawings. In the following, for example, the terms “ink repellency,” “ink-repellent film,” and “ink-repellent member” are described, but may be read as “water repellency,” “water-repellent film,” and “water-repellent member” assuming an aqueous ink. In addition, when the present invention is carried out, it is not necessarily required to limit the kind and application of a liquid, and hence the terms “ink repellency,” “ink-repellent film,” and “ink-repellent member” may be read as “liquid repellency,” “liquid-repellent film,” and “liquid-repellent member” in the following description. The embodiments described below are examples, and for example, the detailed configuration may be appropriately changed and carried out by a person skilled in the art without departing from the spirit of the present invention.

In the drawings referred to in the description of the following embodiments and Examples, elements denoted with the same reference symbols have the same functions unless otherwise stated. In addition, the description “XX or more and YY or less” or “from XX to YY” representing a numerical range means a numerical range including XX (lower limit) and YY (upper limit) that are end points unless otherwise stated. When the numerical ranges are described in stages, the upper limits and lower limits of the respective numerical ranges may be freely combined.

Herein, a liquid to be handled may be described as “ink”, but the ink is not limited to a liquid for forming a character or an image. For example, the ink may be a liquid containing a functional material for forming a functional thin film, such as an electrode or an optical filter, or a functional element such as an organic EL element. In addition, ejecting a liquid to be applied to an object may be described as “recording”, but the term “recording” as used herein is not necessarily limited to recording information, such as a character or an image. For example, the term encompasses applying the liquid to the object in order to produce an article, such as a functional thin film, a functional element, or a three-dimensional molded article.

An ink-repellent member according to the present invention is an ink-repellent member including an underlying portion containing an inorganic oxide, the ink-repellent member having a fluorine compound bonded to a surface of the underlying portion, wherein the fluorine compound has a chain structure, and is bonded to the surface by forming a phosphonic acid ester structure at each of both ends thereof.

The term “ink-repellent member” as used herein refers to a member including an underlying portion having a surface to which a fluorine compound is bonded (member including an underlying portion having a fluorine compound bonded to a surface thereof). The ink-repellent member may be used as, for example, various apparatus that preferably have ink repellency, for example, an apparatus to which an ink may adhere such as an ink jet head or a machine using the ink, or a member of the apparatus. The fluorine compound forms an ink-repellent film by being bonded to the surface of the underlying portion of the member.

The inventor of the present invention has found that, when the coating of the surface of the underlying portion with the ink-repellent film (fluorine compound) is insufficient, the ability of the ink-repellent member may be reduced owing to prolonged ink contact and sliding. In addition, the inventor of the present invention has made investigations repeatedly in order to obtain an ink-repellent member, in which the underlying portion containing an inorganic oxide is sufficiently coated with the ink-repellent film, and which can maintain the ink resistance and the sliding resistance for a long period of time.

As a result, the inventor of the present invention has found that the above-mentioned object can be achieved by using a fluorine compound having a chain structure, and having a phosphonic acid group (phosphonic acid structure) at each of both ends thereof as an ink-repellent film for production of the ink-repellent member.

When the fluorine compound that can be bonded to the surface of the underlying portion by forming the phosphonic acid ester structure at each of both ends of the chain structure is used as the ink-repellent film, efficient formation of a bond between the surface of the underlying portion and the ink-repellent film can be expected. In addition, the phosphonic acid group supplies a proton (H+) to an inorganic oxide and reacts with an oxygen atom of the inorganic oxide, and hence a hydroxy group (OH group) serving as a reaction point with the fluorine compound can be formed. It is conceived that, with those configurations, the fluorine compound can be bonded to the surface of the underlying portion at high density and the formation of a void portion can be suppressed, and hence an ink-repellent member excellent in ink resistance and sliding resistance can be achieved.

### Ink Jet Head

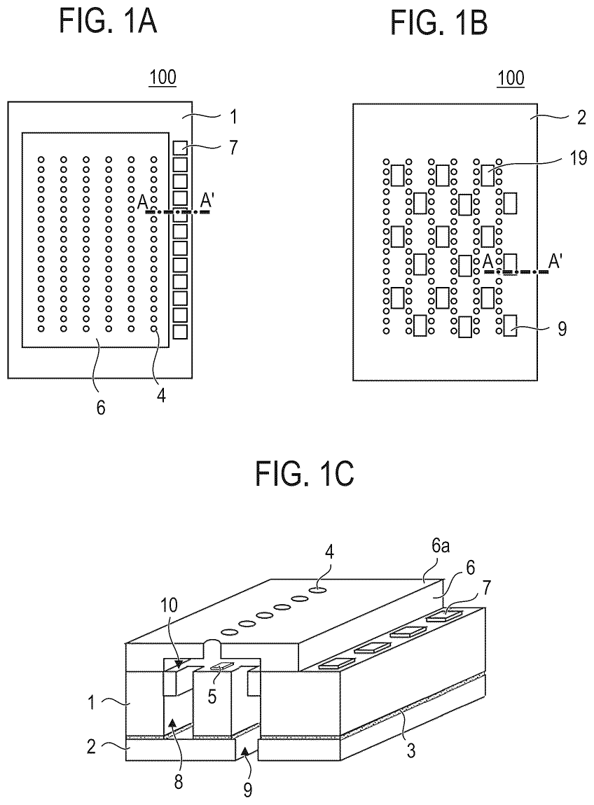

An ink jet head according to the present invention may be an ink jet head including: the ink-repellent member according to the present invention; and an ejection orifice arranged on a side of the ink-repellent member on which the underlying portion and the fluorine compound are arranged, the ejection orifice being configured to eject a liquid. The configuration of the ink jet head according to one embodiment of the present invention is described. FIG. 1A is a top view of an ink jet head 100 according to this embodiment. FIG. 1B is a bottom view of the ink jet head 100. In addition, FIG. 1C is a partial perspective view for illustrating a cross-section taken along the line A-A′ illustrated in FIG. 1A and FIG. 1B.

The ink jet head 100 includes a first flow path substrate 1 serving as a first member, a second flow path substrate 2 serving as a second member, an adhesive layer 3, ejection orifices 4, ejection energy-generating elements 5, an orifice plate 6, electrodes 7, and an ink tank chamber. In this embodiment, the orifice plate 6 may be the ink-repellent member. The illustration of the ink tank chamber is omitted in FIG. 1A to FIG. 1C. In addition, the illustration of components that are not directly related to the description of the present invention (e.g., an electric circuit and wiring) among constituent components of the ink jet head is omitted.

A set of the first flow path substrate 1 and the second flow path substrate 2, a set of the first flow path substrate 1 and the orifice plate 6, and a set of the second flow path substrate 2 and the ink tank chamber are each bonded to be integrated with each other via the adhesive layer 3 to form a flow path structure. In the flow path structure, a first through-flow path 8, a second through-flow path 9 and a third through-flow path 19 are formed and communicate to each other to form an ink supply path. In FIG. 1C, only part of the adhesive layer 3 is illustrated for the sake of convenience in illustration.

The ink is supplied from the ink tank chamber (not shown) to a liquid flow path 10 through the second through-flow path 9 formed in each of the second flow path substrate 2 and the first flow path substrate 1, and is ejected from the ejection orifices 4 after being given ejection energy by the ejection energy-generating elements 5. The ink that has not been ejected from the ejection orifices 4 flows back to the ink tank chamber through the first through-flow path 8 formed in the first flow path substrate 1 and the third through-flow path 19 (circulation return path) formed in the second flow path substrate 2.

Although the plurality of ejection orifices 4 are arranged in the orifice plate 6, an arrangement method (number and position) for the ejection orifices 4 is not limited to the illustrated example. The orifice plate 6 has, on an outer surface thereof, that is, an orifice surface 6a that is a surface on an opposite side to the liquid flow path 10, an underlying portion to be described later, and a fluorine compound is bonded to the surface of the underlying portion. Thus, the ink-repellent film is formed. On the ejection orifices 4 arranged on the orifice surface 6a, the ink-repellent film is not formed. On the first flow path substrate 1, the ejection energy-generating elements 5 for ejecting a liquid are arranged at positions corresponding to the respective ejection orifices 4, and the ejection energy-generating elements 5 are driven in response to an electric signal transmitted from outside via the electrodes 7. For example, electrothermal conversion elements or piezoelectric elements are suitably used as the ejection energy-generating elements 5. Silicon is suitable as a material for a base material of the orifice plate 6, but silicon carbide, silicon nitride, various glasses, such as quartz glass and borosilicate glass, resins such as polyimide, alumina, gallium arsenide, and the like may each be used as the material in addition to silicon. In this embodiment, the orifice plate 6 is formed of the ink-repellent member, but the ink jet head 100 itself may be formed of the ink-repellent member.

### Underlying Portion

The underlying portion to be arranged on, for example, the outer surface (orifice surface 6a) of the orifice plate 6 illustrated in FIG. 1 is formed so as to contain an inorganic oxide.

The underlying portion can form a chemical bond with a fluorine compound having a phosphonic acid group by forming a hydroxy group on a surface thereof.

When the fluorine compound is bonded to the surface of the underlying portion, the adhesiveness of the ink-repellent film (fluorine compound) can be improved. The ink-repellent member may include a base material, and the underlying portion may be formed as an underlying film or an underlying layer on the base material. However, when the base material itself (bulk material) is formed so as to contain an inorganic oxide, the base material itself may be used as the underlying portion.

An oxide, such as tantalum, silicon, zirconium, aluminum, titanium, hafnium, cerium, tungsten, niobium, yttrium, indium, or strontium, may be used as the inorganic oxide. In this embodiment, description is made by taking a tantalum oxide as an example.

The tantalum oxide forms compounds each having a valence of from +2 to +5 as an oxidation number. Of those, tantalum pentoxide is preferred from the viewpoint that a hydroxy group serving as a reaction site can be formed in a large amount. In addition to the tantalum oxide, the underlying portion may further contain oxide materials, such as a silicon oxide, zirconia, alumina, titania, hafnia, cerium oxide, tungsten oxide, niobium oxide, and yttrium oxide.

As the underlying portion containing the tantalum oxide, for example, an underlying film may be formed on a base material (e.g., silicon) by a sputtering method, an ion-assisted vapor deposition method, an atomic layer deposition (ALD) method, or the like. Of those, an ALD method is preferably used from the viewpoint that a high-density film can be formed. When the density is high, ink resistance to an alkaline ink is further improved.

When the underlying film is arranged as the underlying portion on the base material, silicon is generally used as the base material of a lower layer of the underlying film. In this case, the thickness of the underlying film is preferably 10 nm or more, more preferably 50 nm or more from the viewpoint of protecting silicon from an ink. In addition, the thickness is preferably 300 nm or less, more preferably 200 nm or less from the viewpoint of suppressing a cohesive failure at the time of sliding.

### Fluorine Compound

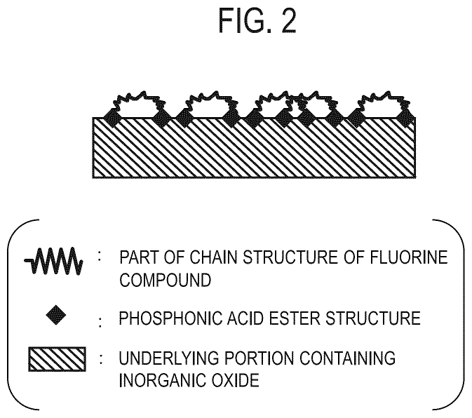

The fluorine compound to be used in the present invention has a chain structure, and is bonded to the surface of the underlying portion containing an inorganic oxide by forming the phosphonic acid ester structure at each of ends on both sides thereof as illustrated in FIG. 2. The fluorine compound to be used in the production of the ink-repellent member has a phosphonic acid group (phosphonic acid structure) represented by the following formula (1) at each of both ends thereof and at least two phosphonic acid groups in the compound to form the phosphonic acid ester structure. When the fluorine compound is bonded to the surface of the underlying portion by forming the phosphonic acid ester structure at each of both ends thereof, the fluorine compound can be bonded to the surface of the underlying portion at high density. Further, it is conceived that, when the fluorine compound has the phosphonic acid group at each of both ends thereof, a proton (H+) is supplied to the inorganic oxide that is present on the surface of the underlying portion, and hence a hydroxy group serving as a reaction point can be formed on the surface of the underlying portion. Accordingly, the effect by which a hydroxy group is formed on a portion of the surface of the underlying portion free of a hydroxy group can be excepted, and hence the density of a bond between the fluorine compound and the surface of the underlying portion can be increased.

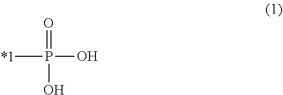

In the formula (1), *1 represents a bonding position in the fluorine compound.

That is, the fluorine compound to be used in the production of the ink-repellent member in the present invention may be represented by, for example, the following formula (F1).

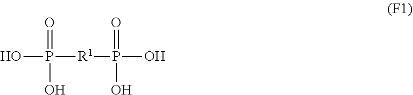

In the formula (F1), R¹ represents a part of the chain structure of the fluorine compound.

The chain structure of the fluorine compound preferably has, as a part thereof, a main chain structure containing a perfluoropolyether structure (hereinafter sometimes referred to as “PFPE structure”) from the viewpoint of ensuring ink repellency and sliding resistance. The fluorine compound preferably has, as the PFPE structure, at least one of a structure represented by the following formula (2), a structure represented by the following formula (3), a structure represented by the following formula (4), and a structure represented by the following formula (5).

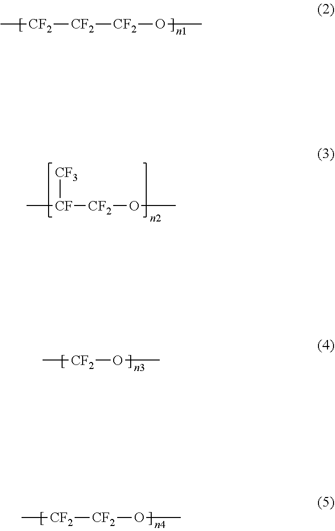

In the formulae (2), (3), (4), and (5), n1, n2, n3, and n4 each independently represent an integer of 1 or more.

A preferred specific example of the fluorine compound to be used in the production of the ink-repellent member is a compound represented by the following formula (6).

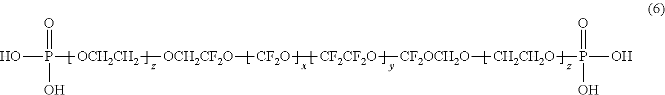

In the formula (6), “x” and “y” each independently represent an integer of 1 or more, and “z” represents 1 or 2.

An example of a compound that is available as the compound represented by the formula (6) may be Fluorolink (trademark) PFPE F10 (manufactured by Solvay Specialty Polymers).

In the ink-repellent member according to the present invention, the fluorine compound is bonded to the surface of the underlying portion by forming such a phosphonic acid ester structure as represented by the following formula (F2) or formula (F3) at each of both ends thereof.

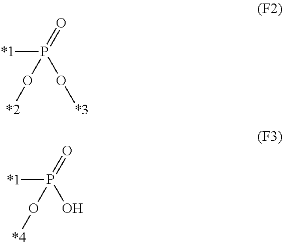

In the formulae (F2) and (F3), *1 represents a bonding position in the fluorine compound, and *2, *3, and *4 each represent a bonding position with a metal atom or a silicon atom on the surface of the underlying portion.

The number average molecular weight of the fluorine compound is preferably 2,000 or more. The number average molecular weight of the fluorine compound may be calculated, for example, by ¹⁹F-NMR measurement.

### Method of Producing Ink-Repellent Member

A method of producing an ink-repellent member including forming an ink-repellent film containing a fluorine compound is described. A method of bonding a fluorine compound to a surface of an underlying portion containing an inorganic oxide to form an ink-repellent film may be performed by dehydration condensation.

First, for example, an underlying film containing an inorganic oxide is formed on a substrate such as an orifice plate, and a hydroxy group is formed on a surface of the underlying film. The inorganic oxide is formed by a formation method, such as sputter deposition using an inorganic oxide target, an ALD method, a chemical vapor deposition (CVD) method, or a spin coating method, but the formation method is not particularly limited thereto.

As a method of forming the hydroxy group on the surface of the underlying film containing an inorganic oxide, there is given, for example, a method of forming a hydroxy group by causing the surface of the underlying film to react with moisture.

Next, a fluorine compound is applied to the surface of the underlying film having the hydroxy group formed thereon. There is no particular limitation on a method for the application, and examples thereof may include a vacuum vapor deposition method, a thermal vapor deposition method, a spray coating method, a spin coating method, and a dip coating method.

Subsequently, a phosphonic acid group that is present at each of both ends of the fluorine compound and the hydroxy group formed on the surface of the underlying film are subjected to a dehydration condensation reaction to form a phosphonic acid ester structure between the fluorine compound and the surface of the underlying film. In addition, a hydroxy group may be formed on the surface of the underlying film by transferring a proton (H+) from a hydroxy group of the phosphonic acid group to a bonding portion between a metal (or silicon) atom and an oxygen atom on the surface of the underlying film.

The dehydration condensation reaction may occur even at room temperature, but may be accelerated by increasing the temperature (e.g. from 100° C. to 120° C.). A reaction time may be appropriately selected in accordance with the temperature, and the reaction time is, for example, about 24 hours at room temperature and about 1 hour under the condition of 120° C.

Subsequently, washing is performed to remove the remaining unbonded fluorine compound. There is no particular limitation on a method for the washing, but for example, it is only required that the orifice plate be immersed in a fluorine solvent that is compatible with the fluorine compound. The washing is performed to the extent that it is visually recognized that the fluorine compound does not remain on the underlying film.

After the fluorine solvent is dried, ink resistance and sliding resistance may be evaluated.

The unbonded fluorine compound may also contribute to an increase in durability, and hence, in general, the unbonded fluorine compound is actively used without being removed in practical use. However, the unbonded fluorine compound is diffused into an ink, for example, during its contact with the ink and is removed over time. As a result, the underlying portion having low liquid repellency is exposed, leading to deterioration of an ink-repellent function. Thus, in each of the evaluations of ink resistance and sliding resistance, the evaluation can be more accurately performed by removing the unbonded fluorine compound.

### Method of Producing Article

A method of producing an article according to the present invention is a method of producing an article including ejecting a liquid through use of the ink jet head according to the present invention, wherein the liquid is an ink containing a functional material for forming one of a functional thin film and a functional element. The article may be an intermediate product or a final product. The method of producing an article according to this embodiment is suitable for producing, for example, an article such as an organic EL (OLED) panel through use of the ink jet head. The method of producing an article of this embodiment is advantageous in at least one of performance, quality, productivity, and production cost of an article as compared to the related-art methods.

### Liquid Ejection Apparatus

A liquid ejection apparatus according to the present invention is a liquid ejection apparatus including: the ink jet head according to the present invention; and a placement portion for an article. The liquid ejection apparatus may include, in addition to the above-mentioned members, for example, a control unit that governs the operation of the apparatus or a carriage on which the ink jet head is mounted and which moves, as required.

### EXAMPLES

### Example 1

Tantalum pentoxide was laminated to 100 nm on a Φ3-inch silicon substrate with an ALD film-forming device.

Next, the silicon substrate having formed thereon tantalum pentoxide as the underlying film was subjected to plasma treatment with a plasma treatment apparatus for the purpose of cleaning.

Subsequently, the silicon substrate in which the surface of the underlying film was treated was immersed in a solution of a fluorine compound, and a fluorine compound FC-1 was applied to the surface having the underlying film formed thereon. The compound having a structure represented by the formula (6) and having a number average molecular weight of 2,300 (Fluorolink (trademark) PFPE F10 (manufactured by Solvay Specialty Polymers)) was used as the fluorine compound FC-1.

The fluorine compound was applied by immersing the silicon substrate for 80 minutes in a 1 mM solution produced by dissolving the fluorine compound in a fluorine solvent (Galden (trademark) SV, manufactured by Solvay Specialty Polymers).

Subsequently, the silicon substrate having the fluorine compound applied thereto was taken out from the solution, followed by air-drying. After that, the resultant was placed in an oven, and was heated at 120° C. for 1 hour to form an ink-repellent film.

Subsequently, the silicon substrate taken out from the oven was washed by immersion in a fluorine solvent for washing for 30 seconds so that an unbonded fluorine compound adhering to the surface was removed. Thus, an ink-repellent member was obtained. The washing was repeated twice with an unused fluorine solvent for washing.

### Example 2

An ink-repellent film was formed to produce an ink-repellent member by the same method as that in Example 1 except that the fluorine compound FC-1 was changed to a fluorine compound FC-2. The compound having a structure represented by the formula (6) and having a number average molecular weight of 1,600 (produced by synthesis) was used as the fluorine compound FC-2.

### Example 3

An ink-repellent film was formed to produce an ink-repellent member by the same method as that in Example 1 except that SiO₂ formed on a surface of the Φ3-inch silicon substrate by heating the surface at 900° C. under an oxygen atmosphere was used as the underlying film.

### Comparative Example 1

An ink-repellent film was formed to produce an ink-repellent member by the same method as that in Example 1 except that the fluorine compound was changed to a fluorine compound FC-3 having a structure represented by the following formula (7) and having a phosphonic acid group only at one end thereof. The compound having a structure represented by the following formula (7) and having a number average molecular weight of 1,600 (produced by synthesis) was used as the fluorine compound FC-3.

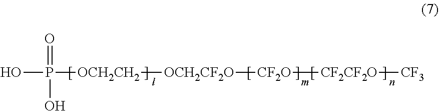

In the formula (7), “m” and “n” each independently represent an integer of 1 or more, and “1” represents 1 or 2.

The specifications of the ink-repellent members according to Examples 1 to 3 and Comparative Example 1 are collectively shown in Table 1 below.

TABLE 1

| | Inorganic oxide | Fluorine compound |
|---|---|---|
| Example 1 | Ta₂O₅ | FC-1 |
| Example 2 | Ta₂O₅ | FC-2 |
| Example 3 | SiO₂ | FC-1 |
| Comparative | Ta₂O₅ | FC-3 |
| Example 1 | | |

Subsequently, the evaluation of the ink resistance of each of the produced ink-repellent members and the evaluation of the sliding resistance thereof are described.

### Evaluation 1: Evaluation of Ink Resistance

The ink resistance of each of the produced ink-repellent members is evaluated by the following procedure. An alkali dye ink (BCI-7C, manufactured by Canon Inc.) was used as an ink. The ink is loaded into a PFA container. The ink-repellent member having formed thereon the ink-repellent film is immersed in the ink so that the entire surface thereof is brought into contact with the ink, and the container is sealed with a lid. The container was placed in an oven in this state, and a temperature of 60° C. was maintained for 1 week. The taken-out ink-repellent member was thoroughly washed with water so that the ink was removed. Then, a contact angle was measured and evaluated by the following method.

### Evaluation 2: Evaluation of Sliding Resistance

The sliding resistance of each of the produced ink-repellent members was evaluated by the following procedure. A high-density felt material (CS-7, manufactured by Taber Industries) was attached to a friction and wear tester (FPR-2100, manufactured by Rhesca Co., Ltd.) as a sliding material, and a reciprocating sliding test was performed on the surface of the ink-repellent member having formed thereon the ink-repellent film. The reciprocating sliding test was performed under the conditions of a sliding load of 650 g, a sliding width of 10 mm, a linear velocity of 50.8 mm/sec, and a number of times of sliding of 6,000. The contact angle of the ink-repellent member after sliding was measured and evaluated by the following method.

### Measurement of Contact Angle

A dynamic receding contact angle θr with pure water is measured with a micro contact angle meter (product name: DM-701, manufactured by Kyowa Interface Science Co., Ltd., analysis software: FAMAS (ver. 3.5.5)) under the following conditions, and the results are ranked based on the following criteria.
Droplets: 2 μL (pure water)
Receding contact angle: the angle was calculated by a sessile drop method.

The receding contact angle was measured specifically by the following method. The contact angle was measured at 80 points at intervals of 15 seconds after the landing of a droplet. The following calculation was performed in the order from a time of 0 seconds through use of the values of the contact angle and the contact radius (unit: μm) at a certain time calculated from the above-mentioned software, and the following processes (A) and (B) were performed.
(A) When the value of a contact radius at a time “t” is represented by Rₜ and the value of a contact radius after t+90 seconds is represented by Rₜ₊₉₀, the value “x” of (Rₜ−Rₜ₊₉₀)² was calculated.
(B) When the value “x” was 200 or less, the process (A) was performed again, and the contact angle at a time “t” when the value “x” first exceeded 200 was defined as the dynamic receding contact angle θr.
A: 100° or more
B: 90° or more and less than 100°
C: less than 90°

The evaluation results of the ink-repellent films according to Examples 1 to 3 and Comparative Example 1 are collectively shown in Table 2 below.

TABLE 2

| | Ink resistance | Sliding resistance |
|---|---|---|
| Example 1 | A | A |
| Example 2 | A | B |
| Example 3 | B | B |
| Comparative | C | C |
| Example 1 | | |

A possible reason why better ink resistance and better sliding resistance are shown in Example 1 than those of Example 3 is a difference in inorganic oxide in the underlying film. When Ta₂O₅ and SiO₂ are compared to each other, Ta₂O₅ has a larger oxygen ratio. Thus, it is presumed that the hydroxy group is formed in a larger amount, and hence the fluorine compound is bonded to the surface of the underlying portion at high density.

In order to satisfy practicality as an ink jet head (ink-repellent member), the dynamic receding contact angle is required to be 90° or more. Thus, it can be said that the ink-repellent members according to Examples 1 to 3, which are evaluated to be A or B for both of the ink resistance and the sliding resistance, have more excellent practical characteristics than those of the ink-repellent member according to Comparative Example 1.

According to the present invention, an ink-repellent member and an ink jet head excellent in both of sliding resistance and ink resistance can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-082824, filed May 21, 2024, which is hereby incorporated by reference herein in its entirety.

What is claimed is:

1. An ink-repellent member comprising an underlying portion containing an inorganic oxide, the ink-repellent member having a fluorine compound bonded to a surface of the underlying portion,
wherein the fluorine compound has a chain structure, and is bonded to the surface by forming a phosphonic acid ester structure at each of both ends thereof.

2. The ink-repellent member according to claim 1, wherein the underlying portion containing an inorganic oxide contains a tantalum oxide.

3. The ink-repellent member according to claim 1, wherein the fluorine compound has a main chain structure containing a perfluoropolyether structure.

4. The ink-repellent member according to claim 1, wherein the fluorine compound has at least one of a structure represented by the following formula (2), a structure represented by the following formula (3), a structure represented by the following formula (4), and a structure represented by the following formula (5): 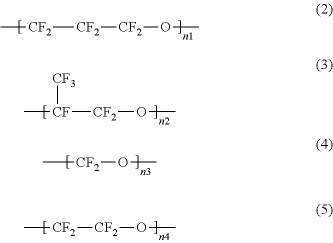
in the formulae (2), (3), (4), and (5), n1, n2, n3, and n4 each independently represent an integer of 1 or more.

5. The ink-repellent member according to claim 1, wherein the fluorine compound has a number average molecular weight of 2,000 or more.

6. The ink-repellent member according to claim 1, further comprising a base material, wherein the underlying portion is arranged on the base material.

7. An ink jet head comprising:
the ink-repellent member of claim 1; and
an ejection orifice arranged on a side of the ink-repellent member on which the underlying portion and the fluorine compound are arranged, the ejection orifice being configured to eject a liquid.

8. A method of producing an article comprising ejecting a liquid through use of the ink jet head of claim 7,
wherein the liquid is an ink containing a functional material for forming one of a functional thin film and a functional element.

9. A liquid ejection apparatus comprising:
the ink jet head of claim 7; and
a placement portion for an article.
